(19) United States
(12) Patent Application Publication
(10) Pub. No.: US 2025/0138573 A1
(43) Pub. Date: May 1, 2025

(54) METHODS AND APPARATUS FOR SYSTEM CLOCK CONTROL

(71) Applicant: Arm Limited, Cambridge (GB)

(72) Inventors: Amit Chhabra, Noida (IN); Sarah Jean Kimber, Sheffield (GB); Stuart James Aitken, Cambridge (GB)

(73) Assignee: Arm Limited, Cambridge (GB)

(21) Appl. No.: 18/925,501

(22) Filed: Oct. 24, 2024

(30) Foreign Application Priority Data
Oct. 27, 2023 (IN) 202311073299
Oct. 27, 2023 (IN) 202311073432
Nov. 24, 2023 (IN) 202311079964
Mar. 20, 2024 (GB) 2403978.6
Mar. 20, 2024 (GB) 2403979.4
Mar. 20, 2024 (GB) 2403983.6

(51) Int. Cl. G06F 1/08; G06F 1/3296

(52) U.S. Cl. CPC G06F 1/08; G06F 1/3296

(57) ABSTRACT

The present techniques relate to a clock control scheme and related methods and circuitry in a system comprising one or more processor cores and there is disclosed a control state machine in a clock controller circuit comprises a sender operable to signal a request to a subordinate state machine and to store a request sent indicator in a store; a first receiver operable to receive an acknowledgement indicator signalled by the subordinate state machine and to clear the request sent indicator in the store; a delay component operable to hold the control state machine in a wait state; a second receiver operable to receive a request complete indicator signalled by the subordinate state machine; and the delay component responsive to receipt of the request complete indicator to release the control state machine from the wait state.

### TECHNICAL FIELD

The present technology relates to a clock control scheme and related methods and circuitry in a system comprising one or more processor cores. In particular, the present technology relates to a clock control scheme, related methods and circuitry therefor in a multi-core system.

### BACKGROUND OF THE DISCLOSURE

Some computer units (e.g. a central processor unit (CPU) or graphics processor unit (GPU)) may require management of their electrical states. For example, a CPU can generate voltage droops due to large changes in current required from a power delivery network (PDN). In another example, there may be a need to dynamically manage the performance of a subsystem by adjusting an operational voltage/frequency. In a further example, there may be a need to make adjustments to clock circuitry based on the current drawn by devices.

In integrated circuits, a droop is a (usually) transient lowering of the voltage in a circuit. This is a well-known phenomenon and can happen because, for example, the power supply dips for some reason below a normal operating voltage of the circuit, because more current is drawn by the conductive elements than the normal current drawn, or because signal interference or noise on the power supply has caused a voltage fluctuation.

Droops can impact the operations of a circuit, for example by reducing the performance of the circuit and thus leading to longer processing times. But there may be more serious effects also—for example, if the circuit draws more current to maintain the level of performance, this can lead to increased power consumption and the concomitant heat dissipation problems, which can lead to reduced life of the device and in severe cases, a complete device failure. Droops can also cause data corruption or errors in the output. This is a very serious issue for applications that depend on the accuracy and reliability of the chip, for example, in safety-critical applications, such as automotive or avionics systems.

Droop mitigation is thus of importance in many systems. Further, in modern systems, there may be implemented additional functionality, such as dynamic frequency and voltage scaling (DVFS), which permits continuous, or near continuous, dynamic management of the power consumption of a device. Using DVFS, for example, the voltage and clock frequency can be adjusted in real time to respond to the changing needs of the system.

Similarly, in some systems, there may be performance problems when there are unforeseen changes in current demand, and these changes may require Intervention to prevent consequent performance issues.

All these systems can operate to mitigate problems in various aspects of the operation of the system, but it will be appreciated that the inter-operation of such complex systems brings its own issues-it is, for example, not easy to balance the possibly competing interests of managing power consumption while maintaining a required level of performance. There is thus a need for mitigation or improvement action to address the complexity of managing the various components of the system to balance these requirements in as near to an optimal state as possible.

### SUMMARY OF THE DISCLOSURE

The present technology relates to addressing or mitigating such control issues or improving known performance management techniques.

According to a first aspect, there is provided a control state machine in a clock controller circuit comprising a sender operable to signal a request to a subordinate state machine and to store a request sent indicator in a store; a first receiver operable to receive an acknowledgement indicator signalled by the subordinate state machine and to clear the request sent indicator in the store; a delay component operable to hold the control state machine in a wait state; a second receiver operable to receive a request complete indicator signalled by the subordinate state machine; and the delay component responsive to receipt of the request complete indicator to release the control state machine from the wait state; wherein the control state machine is configured to control the operation of at least one of: droop mitigation; a hardware acceleration during DVFS transition; and a hardware mechanism to reduce current in real time in event of over current.

The request may comprise a configuration instruction. The subordinate state machine may comprise a droop control state machine. The request may comprise a request to mask droop control or a request to activate droop control. The subordinate state machine may comprise a dynamic voltage and frequency scaling DVFS state machine.

The control state machine may be further operable, prior to operation of the sender operable to signal a request to the subordinate DVFS state machine, to emit to a bus a plurality of DVFS request parameters.

The request may comprise an instruction to transition from a first DVFS state to a second DVFS state. The subordinate state machine may comprise an over-current state machine.

Seen from a further aspect, the present technology provides a method of operation of a control state machine in a clock controller circuit, comprising signalling a request to a subordinate state machine and storing a request sent indicator in a store; receiving an acknowledgement indicator signalled by the subordinate state machine and clearing the request sent indicator in the store; holding the control state machine in a wait state; receiving a request complete indicator signalled by the subordinate state machine; and responsive to receipt of the request complete indicator, releasing the control state machine from the wait state; wherein the control state machine is configured to control the operation of at least one of: droop mitigation; a hardware acceleration during DVFS transition; and a hardware mechanism to reduce current in real time in event of over current.

The method may include functioning steps of any of the components discussed with reference to the first aspect.

According to a further aspect, there is provided a system comprising: the above circuitry, implemented in at least one packaged chip; at least one system component; and a board, wherein the at least one packaged chip and the at least one system component are assembled on the board.

According to a further aspect, there is provided a chip-containing product comprising the above system assembled on a further board with at least one other product component.

According to a further aspect, there is provided a non-transitory computer-readable medium to store computer-readable code for fabrication of the above circuitry.

In a further implementation, there may be provided a computer program comprising computer program code to, when loaded into a processor and executed thereon, cause the processor to perform the method according to an implementation of the present technology. The computer program may be embodied as a non-transitory computer-readable medium comprising computer program instructions to when loaded into a processor and executed thereon, cause the processor to perform the method according to an implementation of the present technology. In a variant, there may be provided a computer program operable to adapt a host processing system to provide an execution environment permitting operation of non-native processor instructions to perform the steps of the method according to an implementation of the present technology.

### BRIEF DESCRIPTION OF DRAWINGS

Embodiments of the present technology will now be described by way of example only and with reference to the accompanying drawings, in which:

FIG. 1 schematically shows a high-level diagram of a system having a clock control circuit within which the present technology is operable;

FIG. 2 schematically shows a block diagram of one possible arrangement of state machines according to an implementation of the present technology;

FIG. 3 schematically shows a set of flows on a timeline according to an implementation of the present technology in which a control state machine is operable to control a DVFS state machine;

FIG. 4 schematically shows a simplified flow diagram of a method of operation of a system comprising according to one implementation of the present technology; and

FIG. 5 illustrates a system and a chip-containing product.

### DETAILED DESCRIPTION

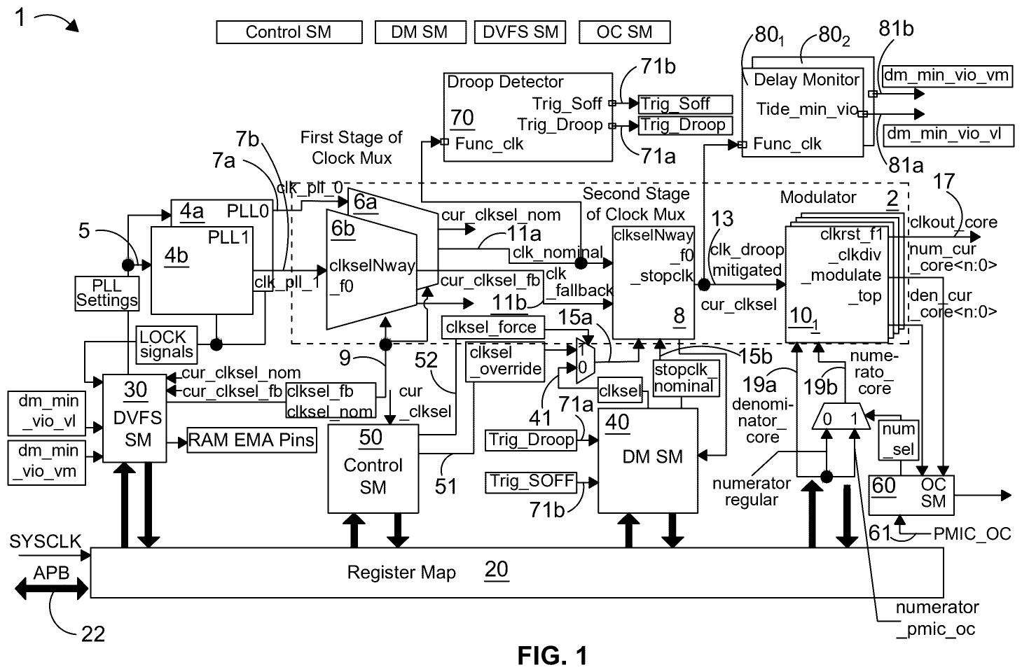

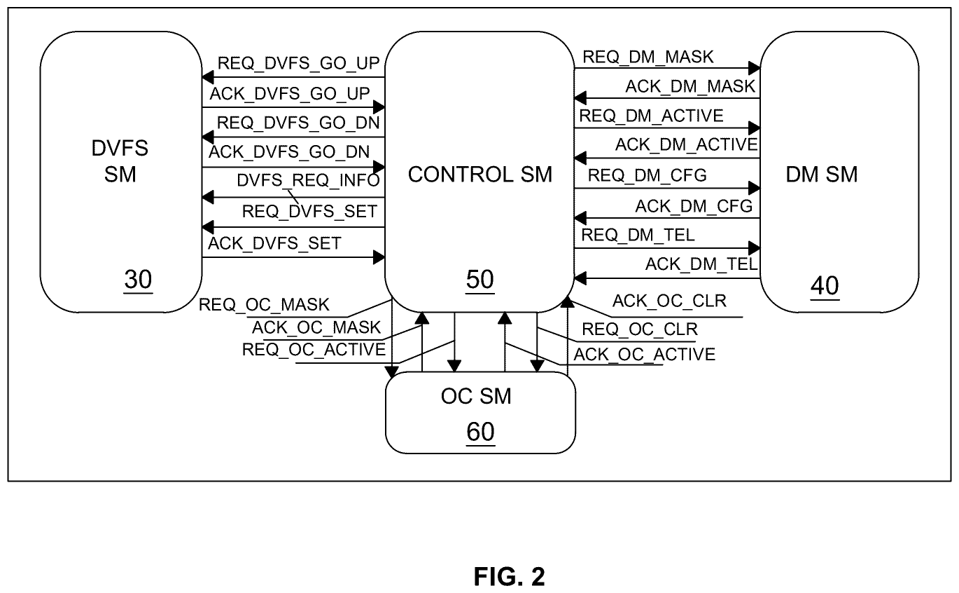

FIG. 1 schematically shows a diagram of a circuit system 1 (e.g. of a system on chip) having a clock control circuit 2 and where FIG. 2 schematically shows features of the clock control circuit 2 in more detail.

It will be appreciated that the term “signal” is non-limiting and may take any form to convey a message, operation or information to a component (hardware or software), where, for example, the signal may comprise one or more bits, a logic value (e.g. high or low), or a voltage value etc. In embodiments the signal may comprise a clock signal having a particular frequency and or level (e.g. voltage level).

Furthermore, the signals provided to a component (e.g. hardware or software) to control the operation thereof (E.g. to select a particular clock signal) or to change properties thereof (e.g. to cause the component to operate in a certain way) may be referred to as a “control signal.”

In the present example, the control signals provided to the clock control circuit 2 may be provided from circuity comprising (e.g. configured to operate as) state machines 30, 40, 50, 60 as will be described in detail below. Furthermore, clock signals may be provided to clock pins of the components of the clock control circuit 2. The clock control circuit 2 and clock sources and other state machines 30, 40, 50, 60 are taken to operate as a clock control state machine (CCSM). The state machines may be implemented as hardware and/or software. In embodiments, the state machines are implemented as fixed function hardware. The state machines may access, for example, storage to generate the signals to control the clock control circuit 2 (or other state machines) in response to the data/values (e.g. one or more bits) therein. In the present illustrative example, the storage comprises a plurality of registers, where one or more of the registers may be programmable.

The state machines may access (read and/or write) registers of register map 20 as required for a particular operation. The register map 20 may be accessed by components of the system 1. The registers may also be accessed by, for example, firmware (e.g. during start-up), where the firmware may access the registers, for example, via an interface such as an Advanced Peripheral Bus (APB), which may be part of the Advanced Microcontroller Bus Architecture (AMBA) protocol family, although the claims are not limited in this respect.

Clock control circuit 2 receives a plurality of clock signals from clock sources 4n (where “n” is an integer, n>1), where clock source₀ 4a & clock source₁ 4b, are shown in FIG. 1. In the present embodiment the clock sources 4a & 4b are phased locked loops (PLL), where each clock source provides a clock signal having a voltage and frequency. However, the claims are not limited to the clock sources being PLL and in a further embodiment the clock source 4b may be a derivative of clock source 4a. For example, the clock source 4b may be a divided clock of the first clock source 4a. In a still further embodiment the first and second clock sources 4a & 4b may be fixed clock sources from different units. In the present embodiment, where the clock sources 4a & 4b are PLLs, each clock source 4a/4b receives one or more PLL signals 5 to configure the properties of the clock signals and supplies the clock signal 7a, 7b to the clock control circuit 2.

In the present illustrative example, a Dynamic Voltage and Frequency Scaling (DVFS) state machine 30 provides the PLL signals 5. The properties of the PLL signals may be set in response to requests from the control state machine 50 dependent, for example, where a request from control state machine may request the DVFS state machine 30 to, for example, perform a set of tasks that are required to configure the PLL in accordance with a DVFS sequence. Furthermore, the control state machine 30 may send requests to the DVFS state machine 30 to increase or decrease a target voltage/operating point (OPP) dependent on an existing OPP (e.g. as defined in one or more registers). The control state machine 50 may also request the DVFS state machine to perform other tasks such as, for example, to configure a RAM (Random access memory) EMA (extra margin adjustment), where the DVFS state machine 30 drives the EMA related pins of the RAM, and where the RAM pin states are dependent on, for example, the type of bit cell, memory architecture and the voltage of operation.

The clock control circuit 2 comprises a first clock path stage comprising multiplexers 6a, 6b, which are controlled, responsive to clock select signal 9 (depicted as clksel_nom or clksel_fb in FIG. 1), to cause the first stage to supply a first clock signal 11a which is designated as a nominal clock signal (depicted as clk_nominal) and to supply a second clock signal 11b which is designated as a fallback clock signal (depicted as clk_fallback) to a second clock path stage 8. The nominal clock signal 11a comprises a relatively higher frequency clock that may be provided to a processor (e.g. CPU or GPU) sub-system (e.g. core). The fallback clock signal 11b is a relatively lower frequency clock that may be used when an event (e.g. a droop event) is detected.

In the present illustrative example, the DVFS state machine 30 provides the clock select signal 9 to drive the nominal clock signal or the fallback clock signal to the second clock path stage dependent on, for example, whether an event (e.g. a droop event) is detected. Since the effects of droop are more severe at higher clock frequencies and higher clock voltages, the fallback clock signal, which is to be selected by the clock mux during droop events, has a lower frequency than the nominal clock signal. In an example, the nominal clock signal has a frequency of 3.5 GHz and the fallback clock signal has a frequency of 3 GHz. The second clock path stage 8 provides a clock signal 13 to a modulator stage, where the modulator stage comprises a plurality of modulator units 10₁-10ₘ (where “m” is an integer). In the present example the clock signal 13 is provided from the second clock path stage 8 responsive to signals 15a/15b, where the signals 15a/15b may be provided in accordance with a droop mitigation scheme. Such a droop mitigation scheme may mitigate against the negative effects of voltage droop. In this sense, the output of the clock circuit is taken to be a mitigated clock signal (depicted as clk_droop_mitigated). In the present illustrative example, the signals 15a/15b are provided by a droop mitigation state machine 40 and a control state machine 50 dependent on the properties of a droop event. For example, the droop mitigation state machine 40 and control state machine 50 are used to provide a clock control signal 15a to cause the second clock path stage 8 to select and provide the nominal clock signal 11a or the fallback clock signal 11b to the modulator stage as the mitigated clock signal 13. For example, the droop mitigation state machine 40 is to provide a “clksel” signal 41 which is to cause the second stage 8 to provide either the nominal clock signal 11a or the fallback clock signal 11b to the modulator stage depending on the value of the “clksel” signal 41, and where the control state machine 50 is to provide a “clksel_override” signal 51 which is to override the clksel signal 41, where one of the clksel signal 41 or clksel_override 51 are selected in response to a clksel_force signal 52, which in the present illustrative example is used to control a multiplexer to select between the signals 41 and 51. Furthermore, the droop mitigation state machine 40 is to provide signal 15b to prevent any clock signal to be provided to the modulator stage on detection and for the duration of a particular event (e.g. a droop event). The modulator units 10₁-10ₘ each modulate the mitigated clock signal 13 (e.g. using average power modulation) and provide, responsive to modulator signals 19a/19b the modulated clock signal 17 to a particular sub-system (e.g. a core (not shown)) of a processor unit (not shown).

The modulator units 10₁-10ₘ may operate independently of each other, so as to, for example, independently provide average power modulation per core of a multi-core system. In the present illustrative example, the clock control circuit 2 comprises a modulator unit 10ₓ per core (not shown). The modulator units 10₁-10ₘ may be individually selected and/or the settings thereof may be controlled responsive to modulator control signals (hereafter “modulator signal(s)”, “control signal” or “signal(s)”). The modulator signals 19a/19b may be used to select the modulator unit 10₁ to 10ₘ which is used to modulate the mitigated clock signal 13 and/or to identify the sub-system to which the clock signal 17 is to be provided. The modulator signals 19a/19b may also define how the modulator is to modulate the mitigated clock signal 13. In the present illustrative example, the modulator signal 19a comprises a denominator value which may be obtained from a register (e.g. via register map 20). The modulator signal 19b comprises a numerator value (e.g. depicted as numerator_regular or numerator_pmic_oc), which may be obtained from registers. In the present illustrative embodiment, the fraction of clock pulses present in the output clock signal 17 relative to the mitigated clock signal are taken to be the numerator divided by the denominator. The values of the numerator and denominator can be programmed independently for each modulator unit and stored in the programmable register(s) of register map 20 where the modulator uses to the numerator and denominator values to modify the mitigated clock signal 13 (e.g. to change the frequency) to provide the output clock signal 17.

In the present illustrative example, modulator signal 19b may be selected to be numerator_pmic_oc by an over-current state machine 60, where the over-current state machine 60 provides hardware support for current demand reduction, for example, in the case of a signal 61 (e.g. a warning signal (e.g. a pre-over-current signal)) from a Power Management IC (PMIC) (not shown). As an illustrative example, the over-current state machine 60 receives warning signal 61 and asserts modulator signal 19b to be ‘numerator_pmic_oc’ as opposed to ‘numerator_regular’ when the warning signal 61 is received from the PMIC, where the numerator_pmic_oc value changes the modulator settings to provide a modulated clock signal 17 which reduces the current demand by a sub-system (not-shown) receiving the modulated clock signal 17 in comparison to ‘numerator_regular’ value for the numerator. In embodiments the modulator units 10₁-10ₘ may not alter the clock frequency of the mitigated clock signal 13, but may supress some of the clock pulses e.g. to reduce the current demand of the sub-system.

As described above the state machines 30, 40, 50 and/or 60 may access values/data in registers of register map 20 to generate the control signals to control the clock control circuit 2 (or other state machines) in response to the data/values (e.g. one or more bits) therein. In the present illustrative example, values/data in registers of the register map 20 can be used to configure the settings of state machines in the programmable registers. Examples what the data/values in the registers in the present illustrative embodiments include, but are not limited, to define:
architectural level inputs for the nominal PLL (or clock source);
a bit(s) for enabling the nominal PLL (or clock source);
settings for the clock generator that drives the nominal frequency;
architectural level inputs for the fallback PLL (or clock source);
the settings for the clock generator that drives the fallback frequency;
timer that runs on a fixed frequency system clock. It is used to ascertain voltage stability for both the memory and the logic supply;
a strategy that CCSM uses to determine voltage stability;
a strategy for droop mitigation;
whether a mitigation strategy is enabled;
the mitigation strategy on a droop event;
overrides the existing droop mitigation of stopping the clock during a DVFS transition;
the settings of the Modulator;
the value of the denominator of the Modulator;
the value of the numerator of the Modulator in regular use case;
the value of the numerator of the Modulator when there is a pre-over-current warning from the PMIC;

It will be appreciated that the above examples of data/values in the registers are not exhaustive and are for illustrative purposes only.

As described above, the various state machines 30, 40, 50, 60 may interact and influence the control and/or clock signals generated by one another. Additionally, or alternatively, the system 1 may comprise further components (hardware and/or software components) that may interface with the various state machines 30, 40, 50, 60 and vice versa to influence the control and/or clock signals generated thereby. For example, the various state machines of the CCSM may interface with droop detectors or delay monitors to carry out droop mitigation and DVFS. As an illustrative example, system 1 comprises one or more droop detectors 70, one of which is depicted in FIG. 1. In the present illustrative example, droop detector 70 receives the nominal clock signal 11a and is configured to monitor (e.g. continuously monitor) the nominal clock signal 11a for a voltage droop event. For example, the droop detector 70 may compare the voltage of the nominal clock signal 11a with one or more thresholds (e.g. stored in a register). The droop detector 11 identifies a droop event when the voltage of the nominal clock signal 11a falls below a threshold. On detection of a droop event, the droop detector 70 outputs droop trigger signals, depicted in FIG. 1 as droop trigger signals 71a (TRIG_DROOP) & 71b (TRIG_SOFF). The droop trigger signals are used as inputs to droop mitigation state machine 40 which may, in response to the signals, control which of signals 15a/15b are provided to the second clock path stage 8 and thereby control the mitigated clock signal 13 provided to the modulator units 10₁-10ₘ of the modulator stage in accordance with, for example the register values defining in the droop mitigation strategy.

As a further illustrative example, system 1 comprises one or more delay monitors 80, two of which 80₁ & 80₂ are depicted in FIG. 1. The delay monitors 80 may be located in different locations (e.g. cores, storage etc.) of a processor (e.g. CPU or GPU), or even outside the physical permitter of a processor (e.g., CPU or GPU), with each delay monitor to measure the delays e.g. in a clock cycle of a clock supplied to components at the respective locations. The delay monitors 80₁ & 80₂ receive the mitigated clock signal 13 and in response to an event (e.g. a delay in the clock signal vs an expected delay), the delay monitor that detects the delay event generates a violation signal, where delay monitor 80₁ generates violation signal 81a and delay monitor 80₂ generates violation signal 81b. In the present illustrative example, the violation signal 81a (depicted as (dm_min_vio_vl) comprises a delay monitor violation signal for logic supply and the violation signal 82a depicted as (dm_min_vio_vm) comprises a delay monitor violation signal for memory bit cell supply. However, it will be appreciated that the claims are not limited in this respect, and delay monitors may be provided to generate violation signals for many different areas of a processor (e.g. CPU/GPU sub-system). The violation signals are used as inputs to DVFS state machine 30 to, for example, calibrate DVFS setpoints, manage DVFS transitions and/or to allow the DVFS state machine to check for voltage stability while performing transitions.

The present technology provides for a clock control circuit system 1 (e.g. of a system on chip) having a clock control circuit having a plurality of clock sources, where the system can be configured to provide a clock for, for example, one or more cores of a processor system (e.g. a CPU or GPU). The system comprises various components (e.g. software and/or hardware) which are configured to operate as a CCSM to perform multiple functions such as:
Configuring one or more clock sources, for instance PLL clock sources;
Enabling fast switching between DVFS modes;
Providing support (e.g. hardware support) for droop mitigation (E.g. to reduce voltage margining for timing sign-off to decrease power for a given frequency of operation);
Providing hardware support for reducing current consumption (e.g. in the case of a pre-over-current warning from a PMIC).

Because of the interconnected nature of the operations performed by the various functional state machines-the DVFS state machine, the over-current state machine, and the droop mitigation state machine, to take three examples, it is important to have some form of centralised control over the various functions, and this is achieved by providing a control state machine-the control state machine 50 of FIG. 1. The interconnected nature of the state machines is best demonstrated with reference now to FIG. 2, which shows a block diagram of one possible arrangement of state machines (SM) with some examples of the flows of messages passed on channels therebetween according to an implementation of the present technology.

In FIG. 2, control SM 50 is arranged in electronic communication with dynamic voltage and frequency scaling DVFS SM 30, droop management DM SM 40, and overcurrent OC SM 60. The typical behaviours of the functional state machines 30, 40, 60 are substantially as described hereinabove with reference to FIG. 1. Shown between the state machines are examples of typical requests that would be issued to the state machines to control the respective operations in relation to the clock circuitry and its associated circuitry. In some cases, the requests are simple requests for a single action to be performed, for example REQ_DM_MASK, which causes masking of droop management to pause droop management until REQ_DM_ACTIVE is requested. In other cases, for example DVFS_GO_UP, the request causes a plurality of steps, and these steps within the process may need to be provided with parameters. In all cases, there is a need to provide coordination between the state machines to prevent inconsistencies of behaviour and to ensure that the various operations are performed in appropriate sequence.

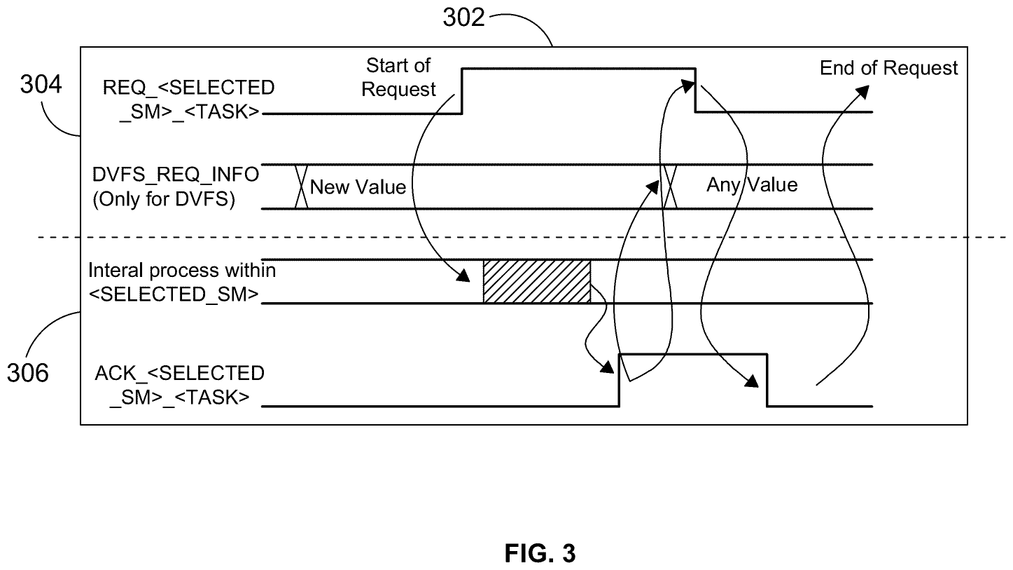

In more detail, FIG. 2 illustrates the different requests that the Control State Machine 50 can make to the functional SMs 30, 40, 60. They are summarized as follows:
Requests to DVFS SM 30 (see also description of FIG. 3, below)
   REQ_DVFS_SET.
      This request is to perform a set of tasks that are required to configure the PLL and the RAM extra margin adjustment (EMA) settings. (EMA refers to a delay associated with a memory access cycle.)
   REQ_DVFS_GO_UP
      This request is to perform a set of tasks that are required to go to a higher voltage/frequency point. The exact sub-task is defined by the DVFS_REQ_INFO bus.
   REQ_DVFS_GO_DN
      This request is to perform a set of tasks that are required to go to a lower voltage/frequency point. The exact sub-task is defined by the DVFS_REQ_INFO bus.
   DVFS_REQ_INFO
      This is a bus that defines the sub-task to be executed in the DVFS sequence. The contents of the sub-task can differ between the REQ_DVFS_GO_UP and REQ_DVFS_GO_DN. The Control State Machine does not need to specify if it is the first or the second step in the DVFS sequence. This information is included in the DVFS_REQ_INFO bus.
Requests to DM SM 40
   REQ_DM_MASK
      This request is to mask the Droop Mitigation State Machine.
   REQ_DM_ACTIVE
      This request is to activate the Droop Mitigation State Machine.
   REQ_DM_CFG
      This request is to configure the Droop Mitigation State Machine.
   REQ_DM_TEL
      This request is to fetch DM Telemetry data from the Droop Mitigation State Machine.
Requests to OC SM 60
   REQ_OC_MASK
      This request is to mask the Over-Current State Machine.
   REQ_OC_ACTIVE
      This request is to activate the Over-Current State Machine.
   REQ_OC_CLR
      This request is to clear the Over-Current State Machine.

To ensure that the various operations are correctly performed with respect to their sequencing and the coordination of the various functional state machines, the control state machine uses a four-state handshaking protocol for communication with the functional state machines.

The four-state handshaking protocol uses a REQuest-ACKnowledge form as follows:
The control SM issues a request to a selected state machine <SELECTED_SM> by raising the REQ_<SELECTED_SM>_<TASK> bit to 1′b1, where “<TASK>” is the request task.
The selected SM processes the request and raises ACK_<SELECTED_SM>_<TASK> bit to 1′b1.
After receiving ACK_<SELECTED_SM>_<TASK> bit, the control SM clears the REQ <SELECTED_SM>_<TASK> bit to 1′b0.
The selected SM clears the ACK_<SELECTED_SM>_<TASK> bit to 1′b0.
When the control SM receives ACK_<SELECTED_SM>_<TASK> bit as 1′b0, the request is complete.

To achieve the required coordination and sequencing of requests to avoid clashes, the control SM finishes the above sequence for each request before moving to any other task.

FIG. 3 shows a set of flows on a timeline 302 according to one example implementation of the present technology in which a control state machine (control SM 50) is operable to control a functional or subordinate state machine, for example, DVFS SM 30. As explained hereinabove, DVFS operations may require a number of sub-operations, and these need to be parameterised and the parameters communicated to the DVFS SM. For this reason, an additional step of providing parameters to a communications means, such as a bus, is needed for DVFS requests. Specifically, for DVFS requests, (referring back to FIG. 2) the control SM 50 must set the type of request in DVFS_REQ_INFO bits before setting the REQ_DVFS_<TASK> bit. As they are no longer required, the DVFS_REQ_INFO bits can have any value when the REQ_DVFS_<TASK> bit is cleared to 1′b0.

FIG. 3 shows, in the section 304 above the horizontal bisecting dotted line, the actions taken and messages passed by control SM 50 to, for example, DVFS SM 30. The actions taken and messages passed by DVFS SM 30 to control SM 50 are shown in the section 306 below the horizontal bisecting dotted line.

As seen in the section 304 above the horizontal bisecting dotted line of FIG. 3, DVFS SM 30 creates parameters for DVFS_REQ_INFO and places them on the bus, and then issues the REQ_DVFS_<TASK> request, in which the <TASK> may for example, be GO_UP using the parameter values supplied by DVFS_REQ_INFO—in this case, the target voltage/frequency values for the REQ_DVFS_GO_UP request.

In the section 306 below the horizontal bisecting dotted line, the DVFS SM 30 signals acknowledgement of the request by setting the acknowledgement indicator (for example to a binary 1), performs its internal processing of the request, and resets the acknowledgement indicator (for example, to a binary 0). When the control SM 50 receives the reset acknowledgement indicator, it knows that the task is complete and it can proceed with further tasks.

As will be clear to one of skill in the art on examining FIG. 3, the request and acknowledgement messages shown have been generalised (for example as REQ_<SELECTED_SM><TASK>) to show that the other functional state machines operate in a similar manner, except that there is no need for them to place parameter values in a bus prior to issuance of the request.

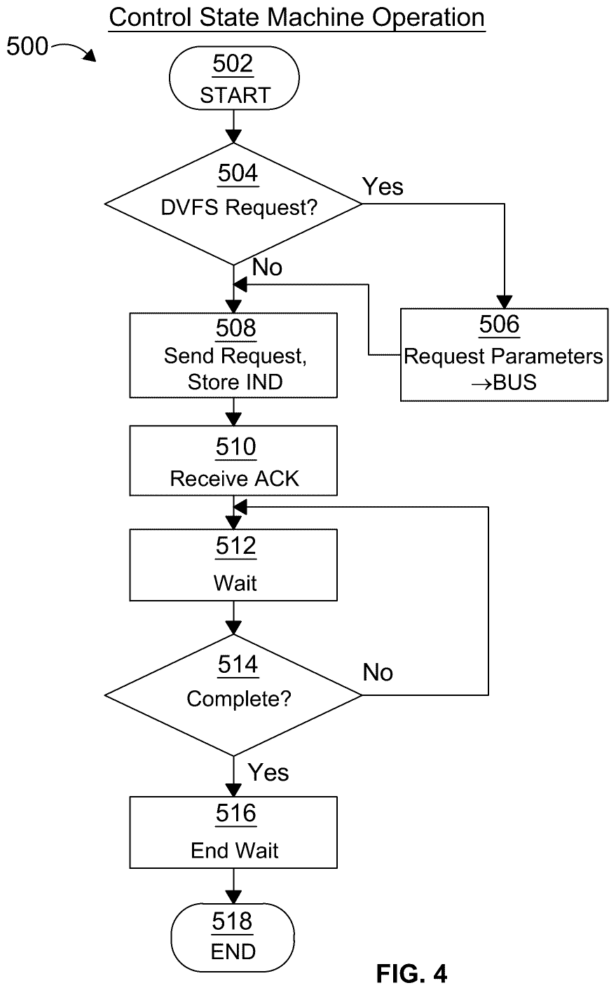

The general case method of operation 500 of the control SM 50 in one basic implementation is as shown now in the simplified flow chart of FIG. 4. The method 500 begins at START 502, when a need has arisen for control of one of the subordinate, or functional, state machines as described hereinabove. At 504 it is ascertained whether or not this is a DVFS request. If it is not, the method proceeds immediately to step 508. If the request is a DVFS request, the request parameters must be constructed and placed on bus 506 before the process continues at 508. At 508, the request is passed to the functional state machine and the indicator is set in some form of store. The indicator may take the form of, for example, a binary flag in a shared register, or it may take any of the other suitable forms of stored indicator that are exposed to the view of the participants. At 510, the acknowledgement is received from the relevant functional state machine, and the control SM 50 is placed in a wait state until the test at 514 indicates that the request has been completed. This may be achieved (as described hereinabove), for example, by the relevant functional state machine resetting the value of the indicator in the shared register when it has completed work on the request, and at 516, the wait state of the control SM 50 is ended. This instance of the operation of the control SM 50 terminates at END 518. As will be clear to one of ordinary skill in the art, this END 518 merely terminates this instance of the method, which may be repeated as necessary from START 502 when a further need arises to control a functional state machine in a clock control system as hereinbefore described.

The control state machine according to the present technology may be implemented in various ways in software, hardware or hybrid forms.

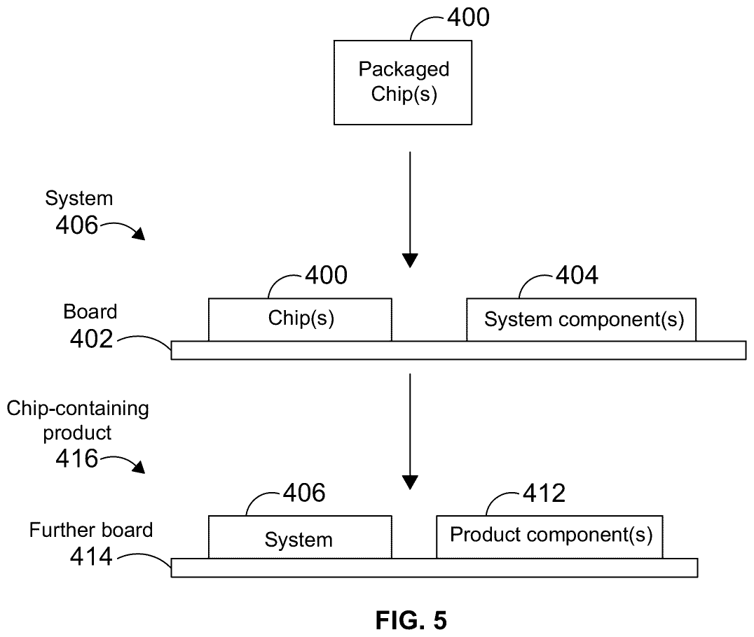

In a hardware form as shown in FIG. 5, one or more packaged chips 400, with the circuitry described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the circuitry described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware. Where the word “component” is used, it will be understood by one of ordinary skill in the art to refer to any portion of any of the above embodiments. The functions of the various elements shown in the figures, including any functional elements labelled as a “block,” “component,” “module” or “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Furthermore, the present techniques may take the form of a computer program product embodied in a non-transitory computer readable medium having computer readable program code embodied thereon. The computer readable medium may be a computer readable storage medium. A computer readable medium may be, for example, but is not limited to, an electronic, magnetic, optical, electromagnetic, infrared, or semiconductor system, apparatus, or device, or any suitable combination of the foregoing. Computer program code for carrying out operations of the present techniques may be written in any combination of one or more programming languages, including object-oriented programming languages and conventional procedural programming languages. The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored using fixed carrier media.

In one alternative, an embodiment of the present techniques may be realized in the form of a computer implemented method of deploying a service comprising steps of deploying computer program code operable to, when deployed into a computer infrastructure or network and executed thereon, cause said computer system or network to perform all the steps of the method.

In a further alternative, an embodiment of the present techniques may be realized in the form of a data carrier having functional data thereon, said functional data comprising functional computer data structures to, when loaded into a computer system or network and operated upon thereby, enable said computer system to perform all the steps of the method.

Those skilled in the art will recognize that the present disclosure has been described by means of examples. The present disclosure could be implemented using hardware component equivalents such as special purpose hardware and/or dedicated processors which are equivalents to the present disclosure as described and claimed.

The techniques further provide processor control code to implement the above-described systems and methods, for example on a general-purpose computer system or on a digital signal processor (DSP). The techniques also provide a carrier carrying processor control code to, when running, implement any of the above methods, in particular on a non-transitory data carrier-such as a disk, microprocessor, CD-or DVD-ROM, programmed memory such as read-only memory (firmware), or on a data carrier such as an optical or electrical signal carrier. The code may be provided on a carrier such as a disk, a microprocessor, CD-or DVD-ROM, programmed memory such as non-volatile memory (e.g., Flash) or read-only memory (firmware). Code (and/or data) to implement embodiments of the techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™, VHDL (Very high speed integrated circuit Hardware Description Language) or SystemVerilog hardware description and hardware verification language. As the skilled person will appreciate, such code and/or data may be distributed between a plurality of coupled components in communication with one another. The techniques may comprise a controller which includes a microprocessor, working memory and program memory coupled to one or more of the components of the system.

The techniques discussed above may be implemented within a data processing apparatus which has hardware circuitry provided for implementing the instruction decoder and eviction controlling mechanisms discussed above. However, the same technique can also be implemented within a computer program which executes on a host data processing apparatus to provide an instruction execution environment for execution of target code. Such a computer program may control the host data processing apparatus to simulate the architectural environment which would be provided on a target data processing apparatus which actually supports target code according to a certain instruction set architecture (ISA), even if the host data processing apparatus itself does not support that architecture. Such simulation programs are useful, for example, when legacy code written for one ISA is being executed on a host processor which supports a different ISA. Also, the simulation can allow software development for a newer version of the ISA to start before processing hardware supporting that new architecture version is ready, as the execution of the software on the simulated execution environment can enable testing of the software in parallel with ongoing development of the hardware devices supporting the new architecture. The simulation program may be stored on a storage medium, which may be an non-transitory storage medium.

Hence, the computer program may comprise instruction decoding program logic which decodes program instructions of the target code to control the host data processing apparatus to perform data processing in response to the non-native program instructions (e.g. mapping each instruction of the target code to a sequence of one or more instructions in the native instruction set of the host which implements equivalent functionality). Also, the computer program may have register emulating program logic which maintains a data structure in host storage of the host data processing apparatus (e.g. in registers or memory of the host) to emulate the register storage of the target ISA being simulated, which one would expect to be provided in hardware in a processor actually supporting the target ISA.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

1. A control state machine in a clock controller circuit, comprising:
a sender operable to signal a request to a subordinate state machine and to store a request sent indicator in a store;
a first receiver operable to receive an acknowledgement indicator signalled by the subordinate state machine and to clear the request sent indicator in the store;
a delay component operable to hold the control state machine in a wait state;
a second receiver operable to receive a request complete indicator signalled by the subordinate state machine; and
the delay component responsive to receipt of the request complete indicator to release the control state machine from the wait state;
wherein the control state machine is configured to control the operation of at least one of:
droop mitigation;
a hardware acceleration during DVFS transition; and
a hardware mechanism to reduce current in real time in event of over current.

2. The control state machine as claimed in claim 1, wherein the request comprises a configuration instruction.

3. The control state machine as claimed in claim 1, wherein the subordinate state machine comprises a droop control state machine.

4. The control state machine as claimed in claim 3, wherein the request comprises a request to mask droop control.

5. The control state machine as claimed in claim 3, wherein the request comprises a request to activate droop control.

6. The control state machine as claimed in claim 1, wherein the subordinate state machine comprises a dynamic voltage and frequency scaling DVFS state machine.

7. The control state machine as claimed in claim 6, further operable, prior to operation of the sender operable to signal a request to the subordinate DVFS state machine, to emit to a bus a plurality of DVFS request parameters.

8. The control state machine as claimed in claim 6, wherein the request comprises an instruction to transition from a first DVFS state to a second DVFS state.

9. The control state machine as claimed in claim 1, wherein the subordinate state machine comprises an over-current state machine.

10. A system comprising a control state machine in a clock controller circuit according to claim 1 implemented in at least one packaged chip; at least one system component; and a board, wherein the at least one packaged chip and the at least one system component are assembled on the board.

11. A chip-containing product comprising the system according to claim 10 assembled on a further board with at least one other product component.

12. A system comprising a control state machine in a clock controller circuit according to any preceding claim 1, a DVFS state machine, a droop control state machine and an over-current state machine.

13. A method of operation of a control state machine in a clock controller circuit, comprising:
signalling a request to a subordinate state machine and storing a request sent indicator in a store;
receiving an acknowledgement indicator signalled by the subordinate state machine and clearing the request sent indicator in the store;
holding the control state machine in a wait state;
receiving a request complete indicator signalled by the subordinate state machine; and
responsive to receipt of the request complete indicator, releasing the control state machine from the wait state;
wherein the control state machine is configured to control the operation of at least one of: droop mitigation; a hardware acceleration during DVFS transition; and a hardware mechanism to reduce current in real time in event of over current.

14. The method of claim 13, further comprising, prior to signalling the request to a subordinate DVFS state machine, emitting to a bus a plurality of DVFS request parameters.

15. A computer program comprising computer program code to, when loaded into a processor and executed thereon, cause the processor to perform the method of claim 13.

16. A computer program operable to adapt a host processing system to provide an execution environment permitting operation of non-native processor instructions to perform the steps of the method of claim 13.

17. A non-transitory computer-readable medium to store computer-readable code for fabrication of circuitry embodying the control state machine according to claim 1.
